(19) United States
(12) Patent Application Publication
(10) Pub. No.: US 2008/0218520 A1
(43) Pub. Date: Sep. 11, 2008

(54) Acceleration of Triangle Scan Conversion Through Minor Direction Detection

(76) Inventors: Graham Sellers, Toronto (CA); Eric Krowicki, Brampton (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/684,360

(22) Filed: Mar. 9, 2007

(51) Int. Cl. G06T 11/20

(52) U.S. Cl. 345/441

(57) ABSTRACT

A method and system for performing triangle scan conversion in a manner that reduces the number of scanlines generated when performing rasterization. The method includes determining a width and a height of a triangle to be rasterized. A minor axis is established in a direction of the shorter of the width and height, and a major axis is established in a direction of the longer of the width and height. A scanline direction is also established so that scanlines will be generated in a direction parallel to the major axis and perpendicular to the minor axis. Furthermore, the scanline direction yields a single major triangle edge and two minor triangle edges, wherein the scanlines begin at the single major triangle edge and terminate at the two minor triangle edges. The method generates the scanlines in accordance with the established scanline direction.

### BACKGROUND

1. The Field of the Invention

The present invention relates to rasterization methods and systems. More specifically, the present invention relates to methods and systems for performing triangle scan conversion in a manner that reduces the number of scanlines generated when performing rasterization.

2. The Relevant Technology

Graphics systems have been improving in performance due to enhanced computational power and specialized circuits that are customized for rendering graphics. The images displayed in modern computers and other display devices typically have an increased number of pixels, color patterns, frame rates, complexity and texture, thereby demanding increased processing power from the graphics system. Furthermore, many applications now require three dimensional modeling, thereby demanding even greater performance from graphic systems. To cope with these requirements, modern graphic systems often include graphics processors designed to handle the large amounts of complex data being sent to the display device.

In the absence of a specialized graphics processor, the computer's CPU would waste considerable processing power performing the necessary graphics calculations. By using graphics systems that are customized to perform graphics calculations, the CPU is free to perform other tasks, thereby improving overall system performance.

A conventional graphics system typically includes a raster image processor for converting an image described in a vector graphics format to a raster image for output on a video display. The raster image processor receives an image described as a plurality of polygons (typically triangles). The triangles, often represented by three vertices in three-space, are transformed into two dimensional triangles, as appropriate. The raster image processor performs triangle scan conversion in order to convert the two dimensional triangle into a pixilated image using a rasterization algorithm.

The pixels are typically sent to a buffer memory, which are later conveyed to a digital to analog converter. The video signal from the converter is output to a display device, such as a computer monitor, a liquid crystal display (LCD), and the like.

Many conventional rasterization algorithms perform triangle scan conversion by generating a horizontal scanline for each pixel row in a triangle. The algorithm typically produces scanlines in the same direction as the buffer memory, i.e., from left to right. Rasterization algorithms typically do not alter the starting points or direction of the scanlines based on the orientation of the triangle being rasterized. Instead, the algorithm begins triangle scanline conversion from a fixed location, e.g. the lower left corner, generates a scanline from left to right, and then steps along one or more triangle edges until the scanline conversion is completed.

The computational cost of stepping along an edge of a triangle during scanline conversion is a non-trivial cost of overall triangle rasterization. Therefore, as average pixel length of scanlines in a given triangle decreases, edge stepping cost relative to scanline emission cost increases, thereby increasing the overall cost of triangle rasterization. Consequently, the conventional technique of generating scanlines from left to right generally achieves its best efficiency for wide triangles with long scanlines comprised of many pixels. When a triangle has a relatively small number of long scanlines, the high computational cost of stepping along the edge(s) of a triangle are kept to a minimum. However, efficiency can be reduced for smaller triangles or for triangles that produce a large number of short scanlines. Where a triangle produces a large number of short scanlines, the high cost of stepping along the triangle edges is increased, and often outweighs the cost of rendering the scanlines.

Furthermore, because many conventional triangle scan conversion algorithms initiate scanlines from left to right, regardless of the orientation of the triangle, the scanlines often originate from two major edges, and terminate at a single minor edge. Major edges include the triangle edges from which scanlines originate. Minor edges include the triangle edges where the scanlines terminate. Initiating scanlines from multiple major edges often requires additional computation costs, thereby further reducing the efficiency of the triangle scan conversion process.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One example embodiment is directed to a method and system of performing triangle scan conversion for improving efficiency when performing rasterization of an image. The image may be described as a plurality of two-dimensional triangles that are randomly oriented, such that some of the triangles are in a predominantly vertical orientation, and other are in a predominantly horizontal orientation. In this example embodiment, a raster image processor determines a width and a height of a triangle to be rasterized. A minor axis is established in a direction of the shorter of the width and height, and a major axis is established in a direction of the longer of the width and height. The raster image processor establishes a scanline direction such that when scanlines are generated, they will be generated in a direction parallel to the major axis and perpendicular to the minor axis. Furthermore, in determining the direction in which the scanlines will be generated, the raster image processor ensures that the scanlines will yield a single major triangle edge and two minor triangle edges. In other words, each scanline will begin at the single major triangle edge and terminate at the two minor triangle edges. The raster image processor then performs the scanline conversion by generating the scanlines in accordance with the established scanline direction.

Variations on this general approach are also illustrated. For example, in another example embodiment, a graphics system is described for efficiently performing triangle scan conversion. The example graphics system includes a raster image processor that is configured to determine a height and width of a triangle to be rasterized. The raster image processor also establishes an edge stepping direction in a direction of the shorter of the height and width of the triangle for reducing a number of scanlines generated while performing triangle scan conversion. The raster image processor also establishes a scanline direction for yielding a single major triangle edge and two minor triangle edges. The raster image processor is further configured to perform triangle scan conversion in accordance with the established edge stepping direction and scanline direction. In this example, the graphics system further includes a buffer memory for storing the scanline data generated by the raster image processor. The illustrated embodiments of performing triangle scan conversion preserve computational resources by minimizing the number of scanlines that are generated for any given triangle, regardless of the orientation of the triangle. Furthermore, establishing a scanline direction such that the scanlines originate from a single major edge and terminate at two minor edges also improves computational efficiency.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only example embodiments of the invention and are therefore not to be considered limiting of its scope. The invention will be described and explained with additional specificity and detail through the use of the accompanying drawings in which:

FIG. 1 illustrates a schematic diagram of an example graphics system configured to conserve processing power while performing triangle scan conversion;

FIGS. 2A, 3A, 4A and 5A illustrate one example of a triangle in a variety of different orientations that has been scanned in accordance with an illustrated triangle scan conversion algorithm;

FIGS. 2B, 3B, 4B and 5B illustrate the example triangle of FIGS. 2A, 3A, 4A and 5A that is also positioned in a variety of different orientations that has been scanned in accordance with one example of a conventional triangle scan conversion algorithm; and

FIG. 6 illustrates a flow diagram of one example of a method for performing triangle scan conversion to improve efficiency when performing rasterization.

### DETAILED DESCRIPTION

In the following detailed description of various embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

Example embodiments of the present invention relate to methods and systems for performing triangle scan conversion in a manner that improves efficiency when performing rasterization. The illustrated examples reduce the number of scanlines generated by establishing an edge stepping direction in the direction of the shorter of the width and height of the triangle, such that the scanlines extend in the direction of the longer of the width and height of the triangle. Computational resources are further preserved by establishing a scanline direction such that the scanlines within a triangle originate from a single major edge and terminate at two minor edges. To accomplish this, a raster image processor is provided that is capable of generating scanlines in all directions, i.e., top-to-bottom, bottom-to-top, left-to-right, and right-to-left.

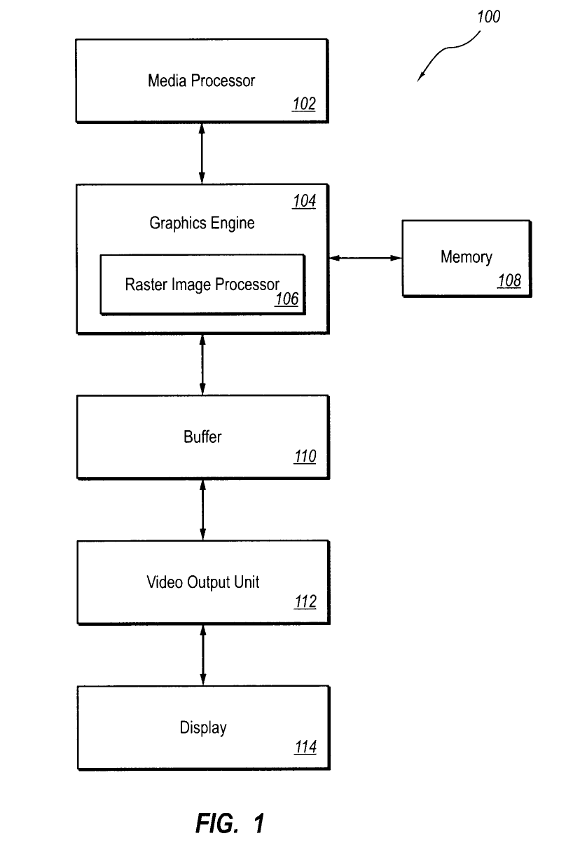

Referring now to FIG. 1, a more detailed example is illustrated using a diagrammed reference to an example embodiment of a graphics system, denoted generally at 100. The illustrated graphics system 100 may include a media processor 102, a graphics engine 104, a memory 108, a buffer 110, a video output unit 112, and a display device 114.

The media processor 102 can be implemented as a specialized processor unit, such as a multimedia processor, a digital signal processor, and the like. The media processor 102 may provide an interface between the graphics engine 104 and a CPU (not shown), or other computer utilizing the illustrated graphics system 100. In one embodiment, the media processor 102 and the graphics engine 104 are separate hardware components. In another embodiment, the media processor 102 and the graphics engine 104 may be integrated within a single hardware component. In certain embodiments, at least a portion of the functionality of the media processor 102 may be implemented in software.

The graphics engine 104 may include a raster image processor 106 for performing triangle scan conversion, in accordance with the present invention. The raster image processor 106 may be implemented as a separate processor unit, or may be integrated with the graphics engine 104. All or part of the functionality of the raster image processor 106 may be implemented in software.

In the example embodiment, the raster image processor 106 may access triangle data and program data from the memory 108. While performing triangle scan conversion, the raster image processor 106 typically fills the interior of a triangle one scanline at a time. For each pixel generated within the triangle, the raster image processor 106 sends a pixel value representing the color and other properties of the pixel to the buffer 110. The properties of the pixel may include, for example, lighting, texture, hue, and the like. Further detail of the triangle scan conversion process will be provided below. When the buffer 110 collects sufficient data from the raster image processor 106, the video output unit 112 uses the pixel data stored in the buffer 110 to display horizontal scanlines on the display device 114.

A detailed description of one embodiment of the scanline conversion performed by the raster image processor 106 will now be provided. Upon identifying a triangle and collecting all necessary data from the memory 108, the raster image processor 106 determines the height and width of the triangle. In order to minimize or reduce the number of scanlines required to fill the triangle, the raster image processor 106 establishes an edge stepping direction in the same direction as the shorter of the height and width of the triangle. The scanlines are generated in a direction perpendicular to the edge stepping direction, i.e., in the same direction as the longer of the height and width of the triangle. In other words, the scanlines are stacked in a direction such that the total number of scanlines necessary to fill the triangle will be minimized, regardless of the orientation of the triangle.

Because a random sampling of triangles will result in some triangles that are in a predominantly horizontal orientation (i.e., width>height) and other triangles that are in a predominantly vertical orientation (i.e., height>width), the raster image processor is capable of generating scanlines in both horizontal and vertical orientations. Therefore, regardless of the orientation of the triangle, the scanlines are oriented such that the total number of scanlines, and thus the total number of edge steps required to traverse the triangle, is reduced or minimized. Because the computational cost of stepping along an edge of a triangle during scanline conversion is a non-trivial cost of overall triangle rasterization, the overall computation cost is reduced by minimizing the number of scanlines required to fill a triangle. The present invention provides a rasterization scheme which keeps the edge stepping cost to a minimum for the benefit of overall performance.

In order to further reduce the computational burden of performing scanline conversion, the raster image processor 106 establishes the direction of the scanlines such that the scanlines always begin at a single major edge of the triangle and terminate at two minor edges of the triangle. As described previously, major edges include the triangle edges from which scanlines originate. Minor edges include the triangle edges at which the scanlines terminate.

By determining which scanline direction results in a single major edge and two minor edges, the raster image processor 106 further conserves processing power because there is no need to switch from a first major edge to a second major edge during the triangle scan conversion. Calculating the origination points of the scanlines is simplified when only a single origination edge (i.e., major edge) is determined. When the origination points begin at the first major edge, and then switch to a second major edge, additional calculations are often required of the raster image processor 106. Therefore, the raster image processor 106 is capable of generating scanlines from top to bottom, bottom to top, left to right, and a right to left, such that the number of scanlines necessary to fill the entire triangle is minimized, and such that all scanlines originate from a single major edge.

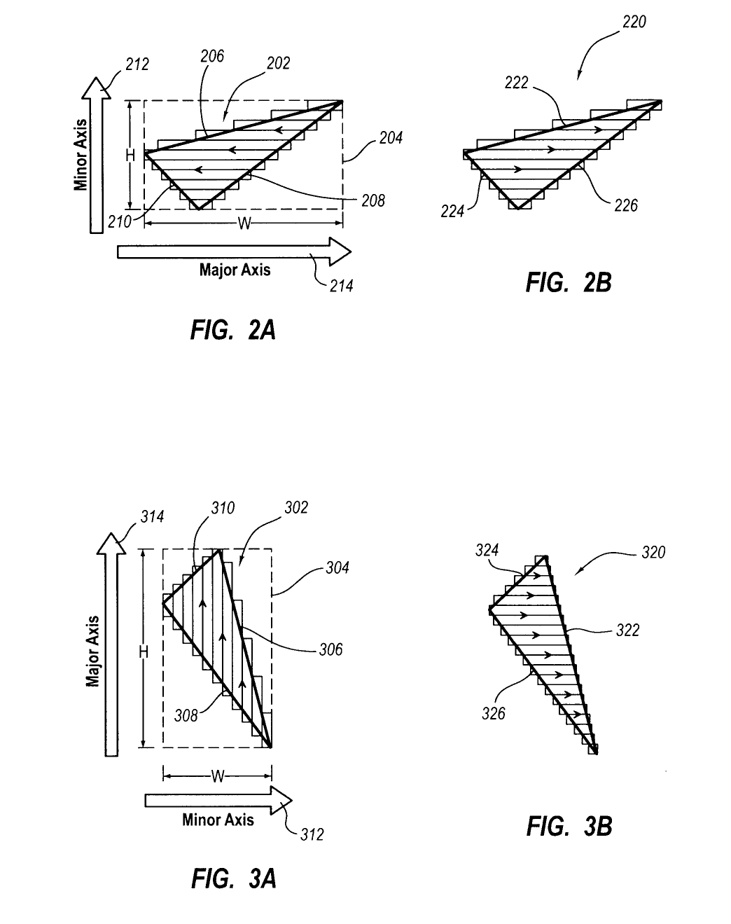

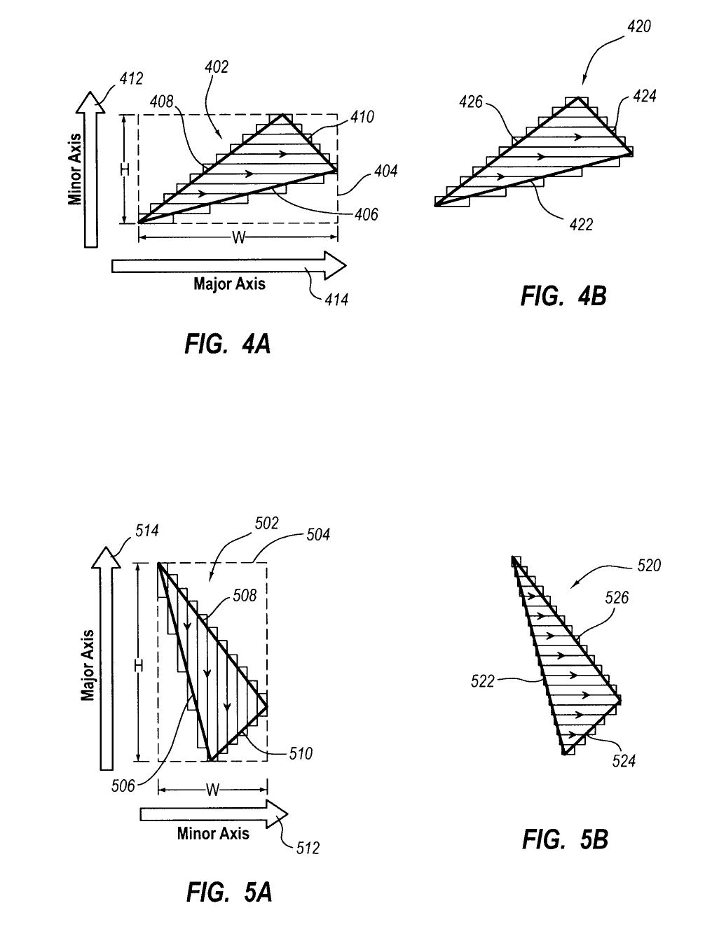

FIGS. 2-5 illustrate various detailed examples of triangles that have been scanned using scan conversion. FIG. 2A illustrates a triangle 202 in a predominantly horizontal orientation. In one embodiment, when determining the width and height of the triangle 202, the raster image processor 106 creates a bounding box 204 surrounding the triangle 202. The height (‘H’) of the triangle 202 may be measured from the bottom edge to the top edge of the bounding box 204. The width (‘W’) of the triangle 202 may be measured from the far left edge to the far right edge of the bounding box 204.

For reference purposes, a minor axis 212 and a major axis 214 may be defined. The minor axis 212 may be established in the direction of the shorter of the height and width, and the major axis 214 may be established in the direction of the longer of the width and height. The major axis 214 and the minor axis 212 need not actually be defined by the raster image processor 106, but instead may be employed herein solely for the purpose of providing reference directions in relation to the orientation of the triangle 202.

The raster image processor 106 establishes an edge stepping direction in a direction parallel to the minor axis 212. In other words, the edge stepping direction in the present example may travel in an upward or downward direction. By establishing the edge stepping direction parallel to the minor axis 212, the number of scanlines produced within the triangle 202 is kept to a minimum. The scanlines are the boxes filling the triangles and running parallel with the major axis 214 and perpendicular to the minor axis 212.

The raster image processor 106 further defines a scanline direction such that the triangle 202 has a single major edge 208 and two minor edges 210 and 206. As illustrated by the direction arrows within the triangle 202, the scanline direction for the present example travels from right to left, i.e., from the major edge 208 to the minor edges 210 and 206.

As described previously, many typical triangle scan conversion algorithms generate scanlines from left to right and edge step from the bottom to the top of the triangle, regardless of the orientation of the triangle. FIG. 2B illustrates a triangle 220 having the same dimensions and orientation as the triangle 202 of FIG. 2A. The triangle 220 has been scanned using a conventional scanline algorithm, scanning from left to right and edge stepping from the bottom to the top of the triangle. In this example, the conventional technique happens to scan the triangle 220 using the same number of scanlines generated using the triangle scan conversion technique of the present invention. However, because the conventional technique illustrated in FIG. 2B scans from left to right, regardless of the orientation of the triangle 220, the triangle has two major edges 222 and 224 (i.e., starting edges), and only a single minor edge 226, thereby increasing computational requirements.

FIG. 3A illustrates a triangle 302 in a predominantly vertical orientation that is scanned using the scan conversion techniques of the present invention. A bounding box 304 may be created to surround the triangle 302. The height (‘H’) of the triangle 302 may be measured from the bottom edge to the top edge of the bounding box 304. The width (‘W’) of the triangle 302 may be measured from the far left edge to the far right edge of the bounding box 304.

A minor axis 312 may be established in the same direction as the width because the width is shorter than the height, and a major axis 314 may be established in the same direction as the height because the height is longer than the width. The raster image processor 106 establishes an edge stepping direction in a direction parallel to the minor axis 312. In other words, the edge stepping direction in the present example may travel from left to right or from right to left. By establishing the edge stepping direction parallel to the minor axis 312, the number of scanlines produced within the triangle 302 is kept to a minimum.

The raster image processor 106 further defines a scanline direction such that the triangle 302 has a single major edge 308 and two minor edges 310 and 306. As illustrated by the direction arrows within the triangle 302, the scanline direction for the present example travels from bottom to top, i.e., from the major edge 308 to the minor edges 310 and 306.

FIG. 3B illustrates a triangle 320 having the same dimensions and orientation as the triangle 302 of FIG. 3A. The triangle 320 has been scanned using the conventional scanline algorithm described above, scanning from left to right and edge stepping from the bottom to the top of the triangle 320. In this example, the conventional technique requires a much greater number of scans to fill the triangle 320 in comparison to the number of scans generated using the technique of the present invention. Therefore, in comparison with the technique of the present invention as illustrated in FIG. 3A, scanning of the triangle 320 becomes computationally inefficient due to the large number of relatively short scanlines. Furthermore, because the conventional technique illustrated in FIG. 3A scans from left to right, regardless of the orientation of the triangle 320, the triangle has two major edges 324 and 326, and only a single minor edge 322, thereby further increasing computational requirements.

FIG. 4A illustrates a triangle 402 in a predominantly horizontal orientation, rotated 180° in comparison to the triangle 202 of FIG. 2A. The triangle 402 is scanned using the scan conversion techniques of the present invention. A bounding box 404 may be created to surround the triangle 402. The height (‘H’) of the triangle 402 may be measured from the bottom edge to the top edge of the bounding box 404. The width (‘W’) of the triangle 402 may be measured from the far left edge to the far right edge of the bounding box 404.

A minor axis 412 may be established in the direction of the shorter of the height and width, and a major axis 414 may be established in the direction of the longer of the width and height. The raster image processor 106 establishes an edge stepping direction in a direction parallel to the minor axis 412. In other words, the edge stepping direction in the present example may travel in an upward or a downward direction. By establishing the edge stepping direction parallel to the minor axis 412, the number of scanlines produced within the triangle 402 is again kept to a minimum, despite the difference in orientation.

The raster image processor 106 further defines a scanline direction such that the triangle 402 has a single major edge 408 and two minor edges 410 and 406. As illustrated by the direction arrows within the triangle 402, the scanline direction for the present example travels from left to right, i.e., from the major edge 408 to the minor edges 410 and 406.

FIG. 4B illustrates a triangle 420 having the same dimensions and orientation as the triangle 402 of FIG. 4A. The triangle 420 has been scanned using the conventional scanline algorithm described above, scanning from left to right and edge stepping from the bottom to the top of the triangle 420. In this example, the conventional technique generates the same number of scanlines as was necessary using the technique of the present invention, described in FIG. 4A. The conventional technique illustrated in FIG. 4B is also able to scan the triangle 420 using only a single major edge 426 and two minor edges 422 and 424. However, this accomplishment was a result of chance, and has not performed by design. On the average, with a random distribution of triangles, the conventional scanline technique illustrated in FIGS. 2B, 3B, 4B, and 5B will achieve minimal scanlines and a single major edge in approximately only one in four triangles.

FIG. 5A illustrates a triangle 502 in a predominantly vertical orientation, rotated 180° in comparison to the triangle 502 of FIG. 3A, and scanned using the scan conversion techniques of the present invention. A bounding box 504 may be created to surround the triangle 502. The height (‘H’) of the triangle 502 may be measured from the bottom edge to the top edge of the bounding box 504. The width (‘W’) of the triangle 502 may be measured from the far left edge to the far right edge of the bounding box 504.

A minor axis 512 may be established in the direction of the shorter of the height and width, and a major axis 514 may be established in the direction of the longer of the width and height. The raster image processor 106 establishes an edge stepping direction in a direction parallel to the minor axis 512. In other words, the edge stepping direction in the present example may travel from left to right or from right to left, parallel to the minor axis 512. By establishing the edge stepping direction parallel to the minor axis 512, the number of scanlines produced within the triangle 502 is again kept to a minimum, despite the change in orientation.

The raster image processor 106 further defines a scanline direction such that the triangle 502 has a single major edge 508 and two minor edges 510 and 506. As illustrated by the direction arrows within the triangle 502, the scanline direction for the present example travels from top to bottom, i.e., from the major edge 508 to the minor edges 510 and 506.

FIG. 5B illustrates a triangle 520 having the same dimensions and orientation as the triangle 502 of FIG. 5A. The triangle 520 has been scanned using the conventional scanline algorithm described above, scanning from left to right and edge stepping from the bottom to the top of the triangle 520. In this example, the conventional technique requires a much greater number of scans to fill the triangle 520 in comparison to the number of scans generated using the technique of the present invention. Therefore, in comparison with the technique of the present invention as illustrated in FIG. 5A, scanning of the triangle 520 becomes computationally inefficient due to the large number of relatively short scanlines. In the present example, the triangle 520 results in a single major edge 522 and two minor edges 524 and 526 due to the orientation of the triangle.

As illustrated in FIGS. 2A, 3A, 4A and 5A, the illustrated raster image processor 106 of the present invention is capable of producing scanlines from left to right, right to left, top to bottom, and from bottom to top. Furthermore, by examining the orientation of the triangles, the raster image processor 106 is able to establish an edge stepping direction and a scanline direction that satisfy two conditions. First, the total number of scanlines is kept to a minimum for each triangle, regardless of the triangle's orientation. Second, all scanlines originate from a single major edge and terminate at two minor edges. By utilizing the triangle scan conversion technique in accordance with the present invention, the average number of scanlines necessary to fill the triangles illustrated in FIGS. 2A, 3A, 4A and 5A is reduced when compared to the conventional technique illustrated in FIGS. 2B, 3B, 4B and 5B.

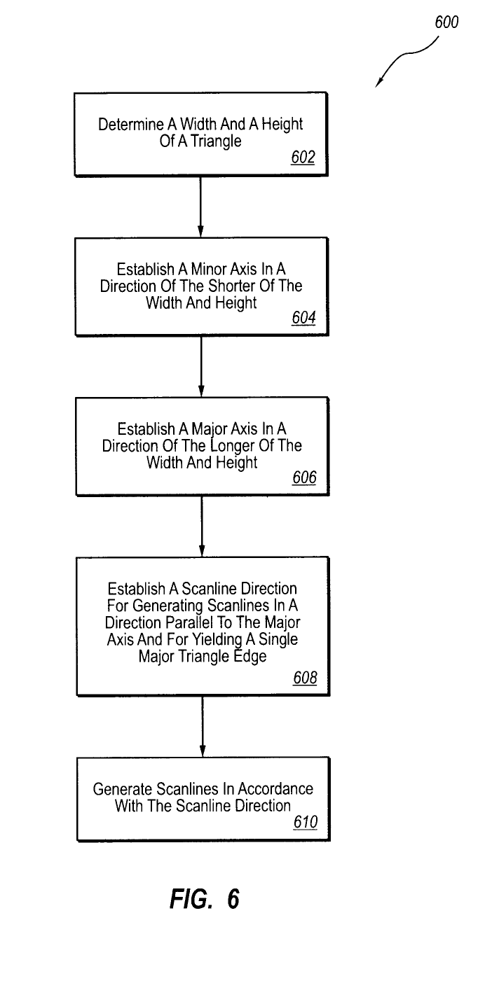

FIG. 6 illustrates one embodiment of an aspect of a method 600 that can be used for performing triangle scan conversion for improving efficiency when performing rasterization. The method 600 may be practiced, for example, in a graphics system including a buffer memory 110 and a raster image processor 106. The graphics system may include one or more computer-readable media having computer-executable instructions, that when executed, implement the method 600. The example method 600 may be used for rasterizing an image made up of a plurality of two dimensional triangles. At the beginning of the process, the raster image processor 106 identifies one of the triangles on which scan conversion will be performed.

The method 600, beginning at step 602, determines a width and a height of the identified triangles. Referring once again to FIG. 2A, in an illustrated embodiment, determining a width and a height of the triangle further includes determining a bounding box 204 for the triangle and determining a width and a height of the bounding box.

At program step 604, the method 600 further includes establishing a minor axis in a direction of the shorter of the width and height, and at step 606, establishing a major axis in a direction of the longer of the width and height. A scanline direction is established, at step 608, for generating scanlines in a direction parallel to the major axis and perpendicular to the minor axis. Furthermore, the scanline direction yields a single major triangle edge and two minor triangle edges. In other words, each scanline begins at a single major triangle edge and terminate at two minor triangle edges. As illustrated in FIGS. 2A, 3A, 4A and 5A, the scanline direction may be selected in either a vertical and a horizontal direction, i.e., from left to right, right to left, top to bottom, or bottom to top.

The method 600 further includes, at program step 610, generating scanlines in accordance with the scanline direction established in step 608. By generating scanlines in a direction parallel to the major axis and perpendicular to the minor axis, computational efficiency is generally improved because the number of scanlines to be rendered during triangle scan conversion is minimized and because only a single major triangle edge is used. The pixels that are generated during scanline conversion may be sent to a buffer memory for temporary storage until the resultant image is ready to be sent to a display device.

In one embodiment, the method 600 is only performed when an area of the triangle is less than a predetermined amount. As described previously, as average pixel length of scanlines in a given triangle decreases, edge stepping cost relative to scanline emission cost increases and overall cost increases as well. Therefore, in certain circumstances where long scanlines are needed to fill a large triangle, the computational resources required to generate the scanlines may partially or fully offset the benefit of orienting the triangle such that the number of scanlines is kept to a minimum. Therefore, it may be beneficial to bypass the method 600 for certain triangles where the size of the triangle exceeds a predetermined amount or when the orientation of the triangle meets a predetermined criteria.

Embodiments herein may comprise a special purpose or general-purpose computer including various computer hardware implementations. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of performing triangle scan conversion for improving efficiency when performing rasterization, the method comprising:
determining a width and a height of a triangle to be rasterized;
establishing a minor axis in a direction of the shorter of the width and height;
establishing a major axis in a direction of the longer of the width and height;
establishing a scanline direction for generating scanlines in a direction parallel to the major axis and perpendicular to the minor axis, and for yielding a single major triangle edge and two minor triangle edges, wherein the scanlines begin at the single major triangle edge and terminate at the two minor triangle edges; and
generating scanlines in accordance with the scanline direction.

2. The method as recited in claim 1, wherein the scanline direction is selected from a vertical and a horizontal direction.

3. The method as recited in claim 2, wherein the scanline direction is selected from a left to right, a right to left, a top to bottom, and a bottom to top direction.

4. The method as recited in claim 1, wherein the method is only performed when an area of the triangle is less than a predetermined amount.

5. The method as recited in claim 1, wherein determining a width and a height of the triangle to be rasterized further comprises:
determining a bounding box for the triangle; and
determining a width and a height of the bounding box.

6. The method as recited in claim 1, wherein establishing the scanline direction for generating scanlines in the direction parallel to the major axis and perpendicular to the minor axis improves computational efficiency by minimizing the number of scanlines to be rendered during triangle scan conversion.

7. The method as recited in claim 1, wherein the triangle is a component within a vector graphics format image.

8. A graphics system comprising:
a raster image processor configured to;
determine a height and width of a triangle to be rasterized;
establish an edge stepping direction in a direction of the shorter of the height and width of the triangle for reducing a number of scanlines generated while performing triangle scan conversion;
establish a scanline direction for yielding a single major triangle edge and two minor triangle edges, wherein the scanlines begin at the single major triangle edge and terminate at the two minor triangle edges; and
perform triangle scan conversion in accordance with the established edge stepping direction and scanline direction; and
a buffer memory configured to store scanline data generated by the raster image processor.

9. The graphics system as recited in claim 8, wherein the raster image processor is further configured to establish the scanline direction in a vertical or a horizontal direction.

10. The method as recited in claim 9, wherein the raster image processor is further configured to establish the scanline direction in a left to right, a right to left, a top to bottom, or a bottom to top direction.

11. The method as recited in claim 8, wherein the raster image processor is further configured to determine a height and width of the triangle by performing the following:
determine a bounding box for the triangle; and
determine a width and a height of the bounding box.

12. The method as recited in claim 8, wherein the established edge stepping direction improves computational efficiency by minimizing the number of scanlines to be rendered.

13. The method as recited in claim 8, wherein the triangle is a component within a vector graphics format image.

14. In a graphics system including a memory and a raster image processor, a computer program product configured to implement a method of performing triangle scan conversion for improving efficiency when performing rasterization, the computer program product comprising one or more computer readable media having stored thereon computer executable instructions that, when executed by the raster image processor, cause the graphics system to perform the following:
determine a width and a height of a triangle to be rasterized;
establish a minor axis in a direction of the shorter of the width and height;
establish a major axis in a direction of the longer of the width and height;
establish a scanline direction for generating scanlines in a direction parallel to the major axis and perpendicular to the minor axis, and for yielding a single major triangle edge and two minor triangle edges, wherein the scanlines begin at the single major triangle edge and terminate at the two minor triangle edges; and
generate scanlines in accordance with the scanline direction.

15. The method as recited in claim 14, wherein the scanline direction is selected from a vertical and a horizontal direction.

16. The method as recited in claim 15, wherein the scanline direction is selected from a left to right, a right to left, a top to bottom, and a bottom to top direction.

17. The method as recited in claim 14, wherein the method is only performed when an area of the triangle is less than a predetermined amount.

18. The method as recited in claim 14, wherein the computer executable instructions that cause the graphics system to determine a width and a height of the triangle to be rasterized further comprise instructions to cause the graphics system to perform the following:
determining a bounding box for the triangle; and
determining a width and a height of the bounding box.

19. The method as recited in claim 14, wherein the computer executable instructions that cause the graphics system to establish a scanline direction for generating scanlines in a direction parallel to the major axis and perpendicular to the minor axis improves computational efficiency by minimizing the number of scanlines to be rendered during triangle scan conversion.

20. The method as recited in claim 14, wherein the triangle is a component within a vector graphics format image.
